(19) United States
(12) Patent Application Publication
(10) Pub. No.: US 2025/0371625 A1
(43) Pub. Date: Dec. 4, 2025

(54) METHODS AND SYSTEMS FOR GROUP MEETING LOCATION SELECTIONS

(71) Applicant: Will Ogden, Hyattsville, MD (US)

(72) Inventor: Will Ogden, Hyattsville, MD (US)

(21) Appl. No.: 18/675,421

(22) Filed: May 28, 2024

(51) Int. Cl. G06Q 50/00; G06F 16/9537; G06Q 10/02

(52) U.S. Cl. CPC G06Q 50/01; G06F 16/9537; G06Q 10/02

(57) ABSTRACT

Methods and devices described herein include using data processing systems for selecting restaurants for a group. The method may include selecting a geographic area comprising one or more restaurants and sending an invitation to one or more users to select one of the restaurants. In some embodiments, upon receipt of acceptance of the invitation, the method or device may send restaurant information of the restaurants in the geographic area to the users. Further some embodiments may receive an indication of selection of one or more restaurants by the one or more of the users, calculate and determine the restaurant having the most selections based on the received indication of selection of one or more restaurants by one or more of the users. In some embodiments, when a restaurant is determined to have the most selections, restaurant information of the determined restaurant is displayed to the users.

### CROSS-REFERENCE TO RELATED APPLICATIONS

This application claims priority to, and the benefit of, U.S. Provisional Patent Application Ser. No. 63/504,727 titled “Method and System for Group Restaurant Selection” filed May 27, 2023 which is incorporated by reference herein.

### BACKGROUND

Groups make decisions in a variety of scenarios. For instance, groups of friends often collectively choose a restaurant at which to meet for dinner. As many have experienced in these scenarios, collectively deciding on a restaurant as a group is difficult, particularly among larger groups facing a large number of options.

Restaurant selection is often challenging because groups often seek to account for diverse individual preferences. Different group members often have differing criteria to determine a suitable restaurant. Complicating the process, group members often have varying levels of conviction about their preferences. Some members may have strong favorable feelings toward a particular location, while others are relatively indifferent to the location, but have strong convictions about a particular restaurant. The problem is often made worse when groups face large sets of options. People often struggle to parse and digest relatively large number of options, especially when selecting dining options, and are often cognitively overloaded through the process. Traversing large sets of options can be taxing and unpleasant for groups, particularly when one person is reading restaurants from a search utility and requesting feedback from other group members.

To the extent groups have attempted to mitigate these challenges, the resulting techniques are often slow, expensive, and cumbersome. For instance, communication within a group facilitates efforts to accommodate diverse individual preferences, but the volume of communication for a decision tends to grow rapidly as the group scales. In-person group meetings mitigate these communication costs, but introduce additional coordination costs, as in-person meetings often introduce new group decision-making choices, such as where and when to meet, and further impose travel and time costs for the meeting. Further, presenting options to the group and tracking and analyzing individual choices is an unpleasant and tedious task, particularly when a large number of options are present. This problem is particularly pronounced for restaurants but is also applicable to other types of meeting locations.

At present, conventional techniques involve running a normal search using a search engine or maps application and then manually proposing options to other parties. Consequently, there is a need felt in the art to locate and agree upon a group consensus for a restaurant option quickly and efficiently.

Additionally, the conventional way of choosing a restaurant causes significant unnecessary taxing of computing resources and processing power and resources through excessive messaging required between participants, and also additional excessive unnecessary web or phone app searching by each participant. In conventional methods, each participant may do their own web or phone app search. The conventional methods used impacts the use of the hardware (e.g., processors and servers) used to implement the inefficient methods.

### BRIEF DESCRIPTION OF THE SEVERAL VIEWS OF THE DRAWINGS

The disclosed examples are described in detail below with reference to the accompanying drawing figures listed below:

FIG. 1A shows a first user view in accordance with one example.

FIG. 1B shows a map screen view in accordance with one example.

FIG. 1C shows a session view in accordance with one example.

FIG. 1D shows a no-session view in accordance with one example.

FIG. 1E shows restaurant selection view in accordance with one example.

FIG. 1F shows restaurant detail view in accordance with one example.

FIG. 1G shows a restaurant match view in accordance with one example.

FIG. 1H shows a restaurant match failed view in accordance with one example.

FIG. 2 illustrates a computing environment implementation in accordance with one example.

FIG. 3 illustrates a computing system in accordance with one example.

FIG. 4 illustrates work flow 400 for selecting a restaurant in accordance with one embodiment.

Corresponding reference characters indicate corresponding parts throughout the drawings.

### SUMMARY

Some aspects are directed to a system of one or more computers may be configured to perform particular operations or actions by virtue of having software, firmware, hardware, or a combination of them installed on the system that in operation causes or cause the system to perform the actions. One or more computer programs may be configured to perform particular operations or actions by virtue of including instructions that, when executed by data processing apparatus, cause the apparatus to perform the actions. One general aspect includes a method in a data processing system for selecting a restaurant for a group. The method may include selecting a geographic area including one or more restaurants. The method also may include sending an invitation to one or more users to select one of the restaurants. The method, in some embodiments may, upon receipt of acceptance of the invitation, send restaurant information of the restaurants in the geographic area to the users. The method also may include receiving an indication of selection of one or more restaurants by the one or more of the users. Additionally, the method may include calculating and determining the restaurant having the most selections based on the received indication of selection of one or more restaurants by one or more of the users. Further, when a restaurant is determined to have the most selections, the method may display the restaurant information of the determined restaurant to the users. Other embodiments of this aspect include corresponding computer systems, apparatus, and computer programs recorded on one or more computer storage devices, each configured to perform the actions of the methods.

Other aspects focus on selecting a restaurant may include the steps of selecting a geographic area including one or more restaurants. The method may also include sending an invitation to one or more users to select the restaurants. The method also includes on receipt of the invitation, sending restaurant information of the restaurants in the geographic area to the users. The method may also include receiving one or more restaurant selections from the users. In some embodiments, The method may include calculating and determining the restaurant having the most selections. The method also may include displaying, based on the selections, restaurant information when the restaurant is determined to have the most selections. Other embodiments of this aspect include corresponding computer systems, apparatus, and computer programs recorded on one or more computer storage devices, each configured to perform the actions of the methods.

Other aspects focus on a data processing system for selecting a meeting location for a group including the steps of selecting a geographic area with one or more meeting locations. The method may also include sending an invitation to one or more users to select one of the meeting locations. The method may further include, upon receipt of acceptance of the invitation, sending meeting location information of the meeting locations in the geographic area to the users.

In some embodiments, the method may include receiving an indication of selection of one or more meeting locations by the one or more of the users. The method also may include calculating and determining the meeting location having the most selections based on the received indication of selection of one or more meeting locations by one or more of the users. The method also may include displaying the meeting location information of the determined meeting location to the users when a meeting location is determined to have the most selections. Other embodiments of this aspect include corresponding computer systems, apparatus, and computer programs recorded on one or more computer storage devices, each configured to perform the actions of the methods.

### DETAILED DESCRIPTION

Embodiments and examples described herein allow a user to select invitees and an area for possible restaurants, automatically display potential restaurants in the area to invitees, and allow the invitees to select a restaurant based on each of their individual preferences. The system then indicates the most-preferred restaurant by the various invitees and notifies the user and invitees of the restaurant.

Methods and systems in accordance with the embodiments and examples herein allow a user to request other users to select a restaurant. A first user may send a request to one or more other users. On acceptance of the request, the first and other users are shown a plurality of restaurants within a geographic radius. The users may then vote on a restaurant. Based on the votes, a restaurant is selected and displayed to the users. The process may also be used to select other meeting locations among groups besides restaurants.

The system and method thereby determine a consensus of the group, allowing each user invitee to make their own choices and then displaying a restaurant selection based on the users' combined selections. In so doing, the system resolves the need felt in the art to locate and agree upon a restaurant option quickly and efficiently based on a group consensus, thereby dramatically simplifying the process of restaurant selection by a group of individuals, saving user time, and saving computing resources.

Additionally, the system positively impacts hardware and computing resources such as processors and servers by eliminating unnecessary excessive messaging required between participants using conventional methods of determining a restaurant for a group. It also eliminates the need for additional excessive unnecessary web or phone app searching by each participant, thereby freeing the computing resources of the processors and servers performing those tasks. The system may help increase performance of device via a centralized server coordinating user communication and selection of meeting locations or restaurants.

Furthermore, the system may also protect the location data of individual group members through various methods including not showing an invitee's location to the user or other invitees and/or requesting permission for the invitee's location before acceptance.

The system may be implemented in a smart phone application. In an embodiment, the first user may open a mobile application (“app”), and enter search parameters specifying a geographic location to see if restaurants are in said location. Methods and systems allow the other users, by use of their smart phone, to indicate an interest in selecting a restaurant and then make their selection from a plurality of restaurants.

The system may be implemented in a smart phone application that a prospective user may use. The user can use the application to contact other users to see if they might be interested in meeting at a restaurant. This initial contact may be made through a user email or text message, but after that, subsequent communication can be done through a chat platform built into the application. For example, a first user could send an invite email or text message or invite chat request to another user. Based on an affirmative response to the request, a user may be invited to take part in the restaurant selection. It is contemplated that the transmission to the users can be by a personalized digital message, such as a text, Instagram message, dynamic advertisement or other electronic transmission.

The other users can be selected by parameters determined by the first user, the other users themselves or a combination thereof. In an embodiment, a restaurant request could be broadcast to a plurality of other users, for example, contacts registered on the user's smart phone. The request could include a list of users attending an event at a restaurant, a potential price range, and a potential meeting location.

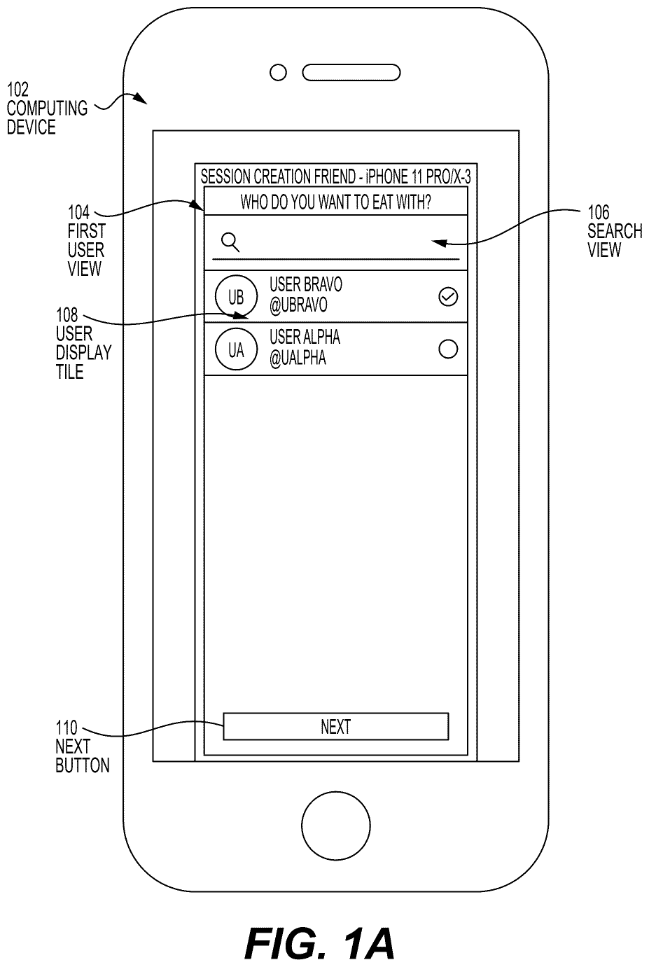

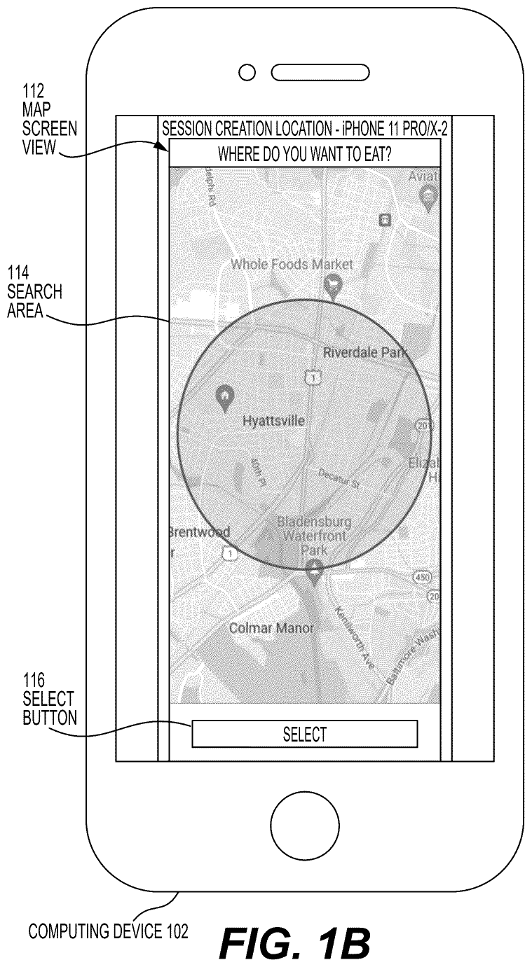

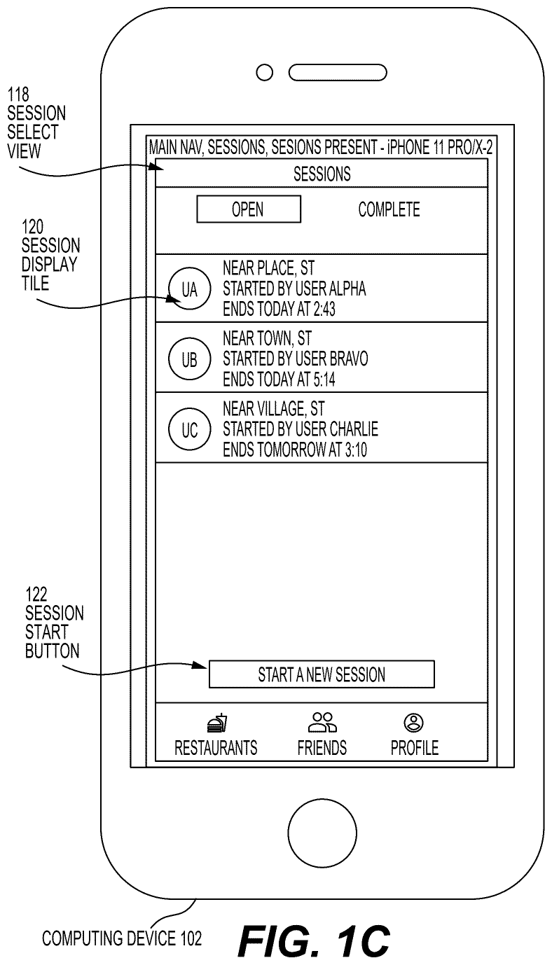

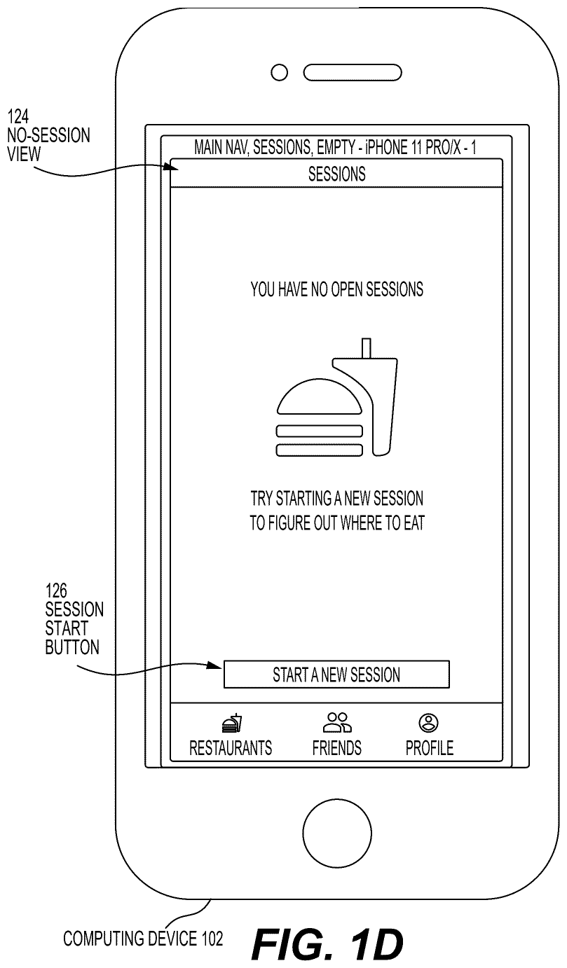

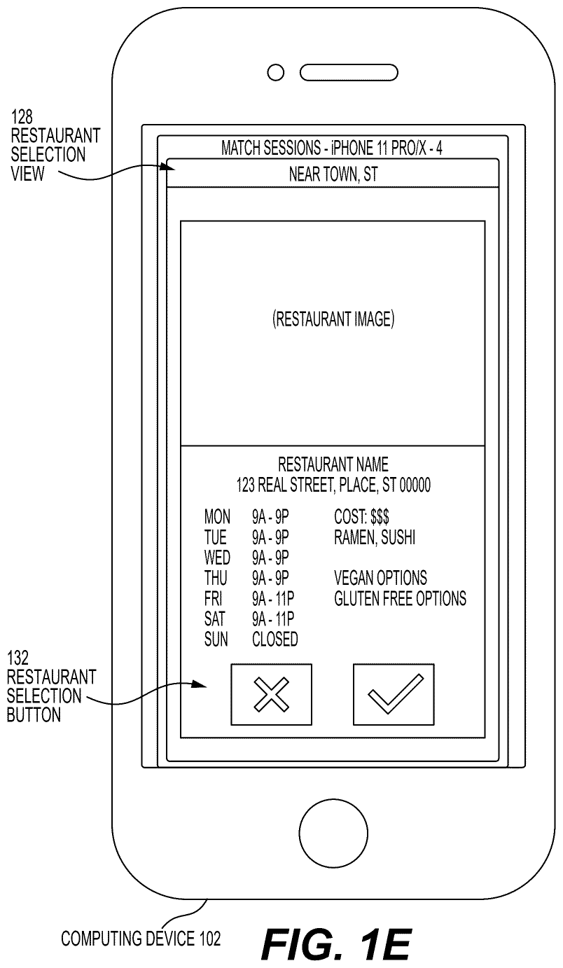

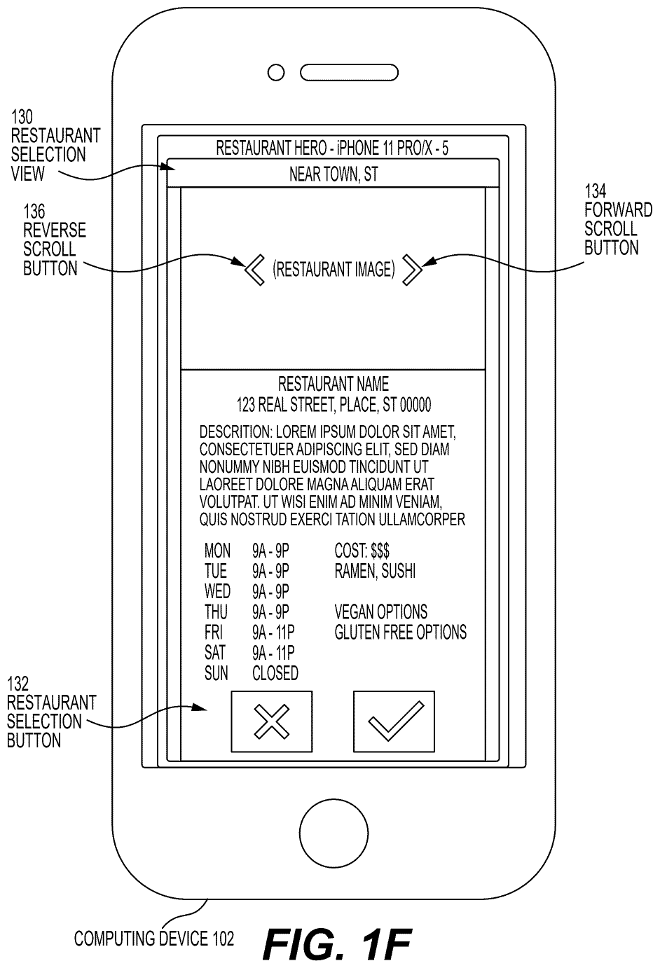

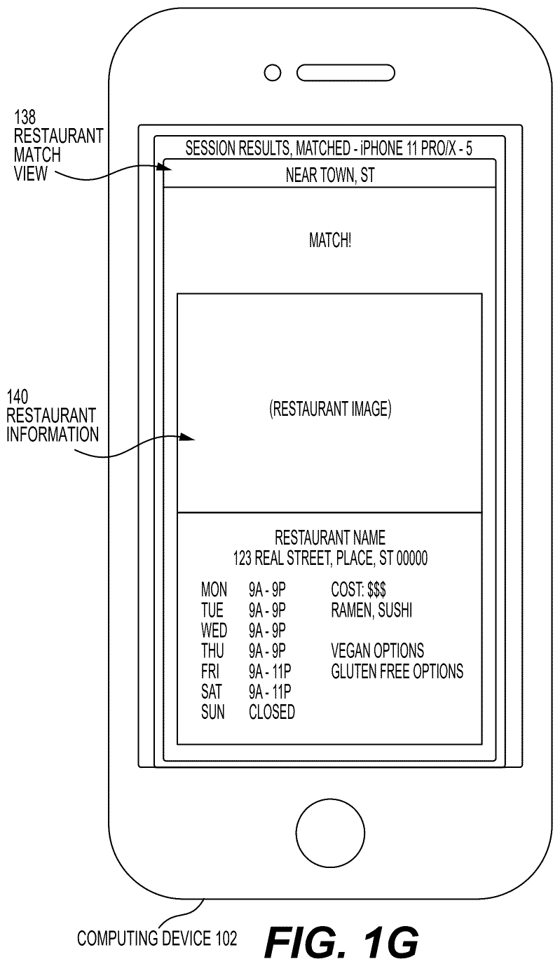

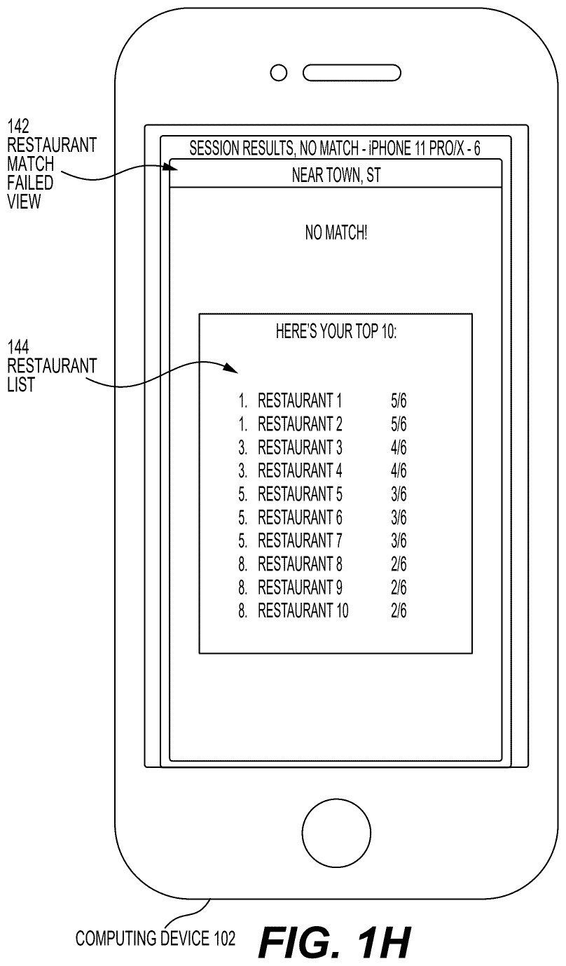

FIG. 1A shows a user's view showing potential invitees to invite including a computing device 102, a first user view 104, a search field 106, a user display tile 108, and a next button 110. Shown in FIG. 1A include a list of users that may be selected based on various user interactions. The computing device 102 may be adapted to display a first user view 104 showing a plurality of second users for selection on a user display tile 108. Search field 106 allows a user to enter criteria for the user display tile 108. For example, the first user may search a contact list alphabetically. The users displayed in the user display tile 108 may be selected by the first user, for example, by a touch screen. Once one or more second users are selected, the user may then select a button such as next button 110 which may lead to a map screen view 112, such as shown in FIG. 1B. In one embodiment, an invitation to the selected users may then be sent, causing the map screen view 112 to be displayed to the first user. In such an embodiment, the user responsible for configuring the session (for example, the first user) may set the location unilaterally. A session, as set up by the user, may be saved remotely on one or more servers along with an identifier. Sessions may be saved as well on the user devices including open as well as complete sessions.

In some embodiments, the user display tile 108 may include one or more list(s) of friends of the first user. In one embodiment, the application may allow users to manage which other users are their friends as well as manage the details of their profile and their personal information.

As shown in FIG. 1B, after clicking the “next” button 110, a map screen view 112, a search area 114, and a select button 116 may be shown. The map screen view 112 may show a geographic area, for example, Washington D.C. The map screen view 112 may display a user-specified search area 114. The user-specified search area 114 may be displayed at different granularities, for example, zoomed in, enlarged, zoomed out, etc. The user-specified search area 114 may be any of various views known in the art such three-dimensional, satellite, street view, etc. The search area may, for example, display one or more restaurants within the search area 114. As illustrated, the search area 114 includes a user-defined circle. The first user could, for example, input a geographic area indicated by a circle by inputting the center and radius. In an embodiment, the first user location may be used as the center of the circle. Any defined search area may be used, such as a square or rectangle. Any shape or indication may be used or performed. Based on the selected geographic area, a plurality of restaurants within the area may be displayed. It can be understood that other types of locations or events may be selected and shared. For example, coffee shops, bars, clubs, museums, parks, stores, groceries, movie theaters or any other location may be selected and shared among devices/users. The user may then select a prominently displayed select button 116 which initiates a match session and leads to a session view 118, shown in FIG. 1C below.

According to some embodiments, the geographic location may be sent to the server, which then may gather a list of matching restaurants or other activities/meeting points, using an external API or, for example, and internal restaurant database. Information about these restaurants or meeting points may be sent to the devices belonging to each of the users involved in the match session.

FIG. 1C shows a session select view 118 with active users. In some implementations, this view may be shown before the views of FIGS. 1A and 1B. The session select view 118 may include a session display tile 120 and a session start button 122. When a user selects one or more other users and a geographic radius, a session may be started. One or more of these ongoing sessions are displayed in the session view 118. A session display tile 120 lists each ongoing session and an end time for the session, at which time the session closes. An open and complete indicator for each session is displayed. An indication such as “Open” may show that the session is still ongoing. When a user selects an open session, each user sees one restaurant or meeting location at a time and is given an option to approve or disapprove of the restaurant by tapping a button (as illustrated in FIGS. 1F-1H). An indicator, such as “Complete” may show that the session is terminated. A user may initiate a new session by tapping a button such as the session start button 122.

A view such as no-session view 124 (e.g., a session select view without active users), as shown in FIG. 1D, may be displayed when all the sessions have ended. In some implementations, this view may be shown before the views of FIGS. 1A and 1B. It is contemplated that FIG. 1D may be displayed initially to the user, for example when there are no active sessions. A session ends when 1) all or a certain specified grouping or number of users involved in the session, approve of a particular restaurant or meeting spot, at which point the matched restaurant or meeting location may be presented to the users (illustrated in FIG. 1G); 2) users move through the list of restaurant or meeting location options and no match is found, at which point all users are presented with a list of the restaurants or meeting locations that were closest to being a consensus pick; or 3) the session times out. In some embodiments, sessions may have a time limit of 24 hours to prevent open-ended sessions with no resolution, and a restaurant match is not found. In some embodiments, when the session times out, a list of restaurants closest to consensus may be presented to all users. In an embodiment, a complete backlog of past match sessions is also available for each user. A user may also initiate a new session by selecting the session start button 122.

Once a restaurant or meeting location is selected, a restaurant view 144 may be displayed to all participating users. In the restaurant list 144, the restaurant name, address, business hours, cost, food type, restaurant food options and other relevant information may be displayed. In an embodiment, an image of the restaurant can also be displayed. In further embodiments, the relevant information for other meeting locations may be presented. For example, for a museum, coffee shop, bar or club, the business hours, parking options, food options, and any additional relevant information may be presented. Further, for example, for a movie theater, a designated start time, price of tickets, duration of the movie, address, name, and parking or travel information may be presented.

As shown in FIG. 1E, during an open session, each user is shown a restaurant selection view 128. The view of FIG. 1E can be displayed when users are scrolling through restaurant or meeting point views and making yes or no selections. The restaurant selection view 128 may display each restaurant within the search area 114. In some embodiments, the total number of restaurants displayed may be limited to a specific number, thereby keeping the selection reasonable and finite. In the restaurant selection view 128, the restaurant (or meeting point) name, address, opening hours, cost, food type, restaurant food options and other relevant information may be displayed. In some embodiments, an image of the restaurant or meeting location may be displayed. The user may select a restaurant selection button 132 to either approve or disapprove of the displayed restaurant or meeting location. In some embodiments, the user may thereby make a binary decision regarding the suitability of a restaurant. In some embodiments, the restaurants may be displayed and/or ordered based not only on the user selections but also based on other criteria, such as a fee paid by the restaurant. The restaurants or meeting locations may, for example, pay a subscription or advertisement fee to the provider of the application, and thus be displayed more prominently (for example, being ordered higher in the scroll list). In some embodiments, when a user is moving through the list of restaurants or meeting locations, and marking them for approval or disapproval, the user may tap on the restaurant details to open this view and get more information on the restaurant or meeting location.

Once a selection has been made, the users may be displayed the next restaurant or meeting location, and the process may be repeated for each restaurant or until a user indicates that he or she wishes to see no more restaurants. The advantage thus provided is that each separate user can move through the list of restaurants or meeting locations, but they may do so individually and at a separate pace from other users. Further, each user may see the restaurant or meeting location options in the same order.

FIG. 1F shows a restaurant detail view 130 showing details and images of the selected restaurant or meeting location. The restaurant detail view 130 may be adapted to allow a user to scroll through the plurality of pictures of restaurants or meeting locations, for example, by a reverse scroll button 136 and forward scroll button 134 displayed laterally to the image and operable by a touch screen. This image may be a “hero” image that switches as a user scrolls through the restaurant's or meeting locations' images.

FIG. 1G shows restaurant match view 138. When a session ends and all users involved in the session approve of a particular restaurant, the system displays a restaurant match view 138 comprising a restaurant information tile 140. A match success indicator may be displayed in a prominent location, size or fashion, for example, the word “Match” may be displayed, or an indication that the restaurant or meeting location is the winner. A restaurant information tile 140 associated with the winning restaurant that shows the name, address, business hours, cost, food type, restaurant food options and other relevant information may also be displayed. In an embodiment, an image of the restaurant, such as a photograph of the front of the restaurant, may be displayed in the restaurant information tile 140. In an embodiment, functionality may include a way to communicate with or call the restaurant or meeting locations, for a reservation or book a reservation through either an internal or external reservation booking or ticketing system.

At the close of a session (for example, when all users have moved through the list of restaurant or meeting location options and no match is found) a restaurant match failed view 142 may be displayed as shown in FIG. 1H. Prominently displayed is a match failed indicator, such as the words “No Match!” The restaurant matches failed view 142 also shows a restaurant list 144. The restaurant list 144 may display a top 10 list of restaurants in an ordered fashion based on user selections. For example, a list of restaurants or meeting locations closest to the match may be presented.

In an exemplary embodiment, initially, a user may be shown the view in FIG. 1C. However, if there are no active sessions, the view as shown in FIG. 1D may be initially displayed to a first user. Based on a first user interaction with either of the views of FIG. 1C and FIG. 1D, a user may be directed to view as displayed in FIG. 1A. Based on a second user interaction, a view as shown in FIG. 1B may be displayed and then a view as shown in FIG. 1E may be displayed. A user interaction (e.g., tapping) may then lead to the view as shown in FIG. 1F or FIG. 1G. For example, any detection of a match may then lead to the view shown in FIG. 1G. If no match is detected and no more restaurants or meeting locations (e.g., restaurant cards) are detected, then the process may continue to the view as shown in FIG. 1H.

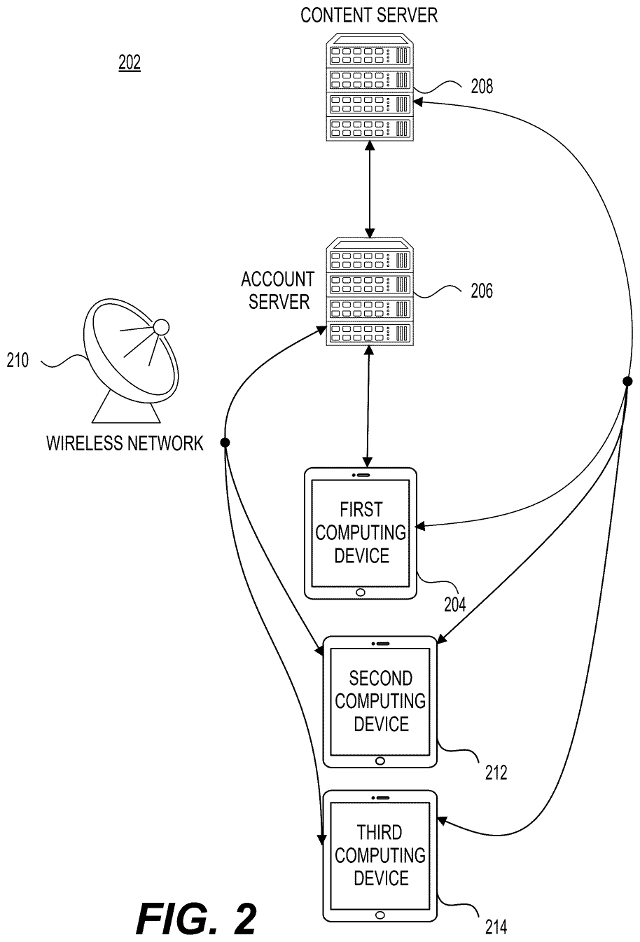

In FIG. 2, an exemplary computing environment 202 for recording, transmitting and scheduling the restaurant selections is illustrated. In FIG. 2, the computing environment 202 comprises a content server 208, account server 206, first computing device 204, second computing device 212 and third computing device 214. The computing environment 202 is adapted to a wireless network 210, such as the Internet, and the content server 208, account server 206 and first computing device 204 are adapted to communicate over the wireless network 210 by means known in the art. Users may interact with the computing environment 202 through any of the computing devices 204, 212, 214 for example, by using a touch screen or voice commands.

The content server 208 and account server 206 (referred to herein collectively as the “server”) are shown as separate entities. However, as is known in the art, the content server 208, and account server 206 may co-exist in the same device. In some embodiments, the content server 208 and/or account server 206 may be in any topography, connection, or regional distribution. In some embodiments, content server 208, and/or account server 206 may be one or more virtual devices, virtual servers or cloud computing devices. For example, one server may host multiple cloud computing devices. Similarly, multiple servers may host various cloud computing devices that makes the system more dispersed geographically. In some embodiments, computing environment 202 may be a cloud computing device comprising multiple storage devices.

The computing devices 204, 212, 214 as shown in FIG. 2 may include, but are not limited to, a home computer, a wireless computing device, a wireless communication device (e.g., a mobile phone configured to access one or more services provided over the wireless network 210), a portable computing device (e.g., a laptop computer, a tablet computer, etc.), and/or personal digital assistant. In some embodiments, the application may also be resident on a website accessible by the computing devices 204, 212, 214. The computing devices 204, 212, 214 may be adapted to send and receive invitations to participate in the restaurant or meeting location selections, display content associated with the restaurant or meeting location selections (e.g., display maps, images or other information associated with the restaurants), and display restaurant selections (e.g., the restaurant list 144). Each computing device 204, 212, 214 may also be adapted to receive votes for a restaurant and calculate a score for each restaurant. The score may include the votes from each of the computing devices 204, 212, 214 and define additional votes to calculate a total score. For example, the additional votes may order a restaurant selection higher in a list of displayed restaurants.

The functionality of the system can be provided by an application resident on computing environment 202, for example, distributed over or resident on one of the computing devices 204, 212, 214, account server 206, and content server 208. The application may include one or more software applications that may be provided to or accessed by and allows users to input and receive data, for example, by a Graphical User Interface (“GUI”) associated with the first computing device 204.

The computing devices 204, 212, 214 may be configured to track (e.g., detect) a geographic location with respect to a user. The tracking of the geographic location of the first computing device 204 may be performed in any suitable way and using any suitable technologies, including, without limitation, Global Positioning System (“GPS”) technologies and terrestrial signaling triangulation technologies. As an example, the computing devices 204, 212, 214 may track the location of the users using GPS and/or cellular phone wireless signaling triangulation technologies.

Content server 208 may be adapted to download and upload content to the computing devices 204, 212, 214. For example, content server 208 may use a direct communication link with the computing devices 204, 212, 214 through a Wi-Fi link to directly download content or upload user-generated content to the content server 208.

Content may include, but is not limited to, restaurant or meeting location name, address, business hours, cost, food type, food or drink options, an image of the restaurant or meeting location, ratings of the meeting location/restaurant, and any other information associated with the restaurant or meeting location. Content may also include geographic maps of an area, user information, and previous user selections.

An account server 206 may be adapted to store a plurality of content settings related to the user account and to allow a user to configure the content displayed on the computing devices 204, 212, 214. The account server 206 may also grant or restrict user access to the system, based on, for example, access privileges or subscription levels.

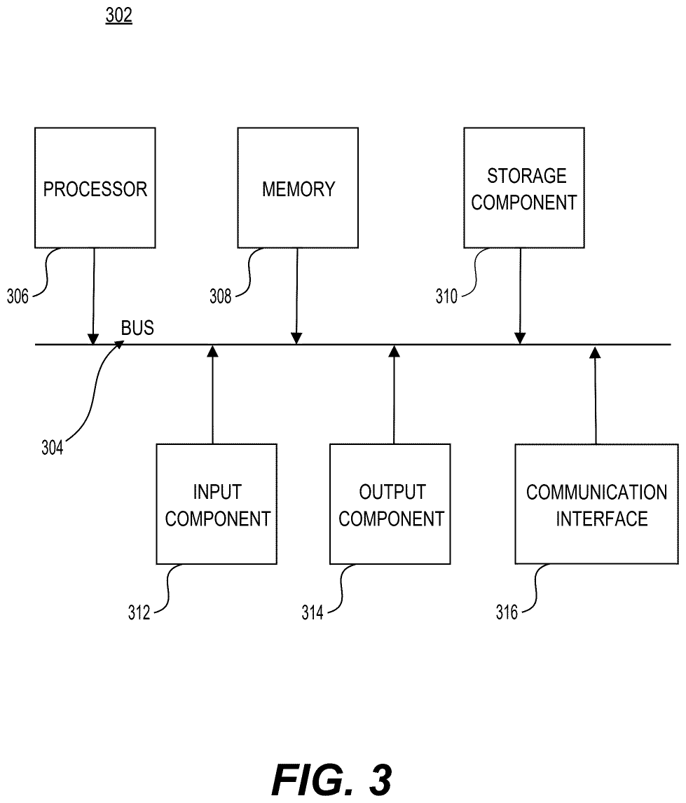

FIG. 3 is a diagram of example components of a device 302, which may correspond to content server 208, account server 206, and computing devices 204, 212, 214. In some implementations, content server 208, account server 206, and computing devices 204, 212, 214 include one or more devices 302 and/or one or more components of device 302. As shown in FIG. 3, device 302 may include a bus 304, a processor 306, a memory 308, storage component 310, input component 312, an output component 314, and a communication interface 316.

Bus 304 may include one or more components that enable wired and/or wireless communication among the components of device 302. Bus 304 may couple together two or more components of FIG. 3 such as via operative coupling, communicative coupling, electronic coupling, and/or electric coupling. Processor 306 may include a central processing unit, a graphics processing unit, a microprocessor, a controller, a microcontroller, a digital signal processor, a field-programmable gate array, an application-specific integrated circuit, and/or another type of processing component. Processor 306 may be implemented in hardware, firmware, or a combination of hardware and software. In some implementations, processor 306 may include one or more processors capable of being programmed to perform one or more operations or processes described elsewhere herein.

Memory 308 may include volatile and/or nonvolatile memory. For example, memory 308 may include random access Memory (RAM), read-only memory (ROM), a hard disk drive, and/or another type of memory (e.g., flash memory, magnetic memory, and/or optical memory). Memory 308 may include internal memory (e.g., RAM, ROM, or a hard disk drive) and/or removable memory (e.g., removable via a universal serial bus connection). Memory 308 may be a non-transitory computer-readable medium. Memory 308 may store information, instructions, and/or software (e.g., one or more software applications) related to the operation of device 302. In some implementations, memory 308 may include one or more memories 308 that are coupled to one or more processors (e.g., processor 306), such as via bus 304. In some implementations, memory 308 may comprise a storage component 310 such as a non-transitory computer-readable medium for storage of memory.

Input component 312 may enable device 302 to receive input, such as user input and/or sensed input. For example, input component 312 may include a touch screen, a keyboard, a keypad, a mouse, a button, a microphone, a switch, a sensor, a global positioning system sensor, an accelerometer, a gyroscope, and/or an actuator. Output component 314 enables device 302 to provide output, such as via a display, a speaker, and/or a light-emitting diode. Communication interface 316 may enable device 302 to communicate with other devices via a wired connection and/or a wireless connection. For example, communication interface 316 may include a receiver, a transmitter, a transceiver, a modem, a network interface card, and/or an antenna.

Device 302 may perform one or more operations or processes described herein. For example, a non-transitory computer-readable medium (e.g., memory 308) may store a set of instructions (e.g., one or more instructions or code) for execution by processor 306. Processor 306 may execute the set of instructions to perform one or more operations or processes described herein. In some implementations, execution of the set of instructions, by one or more processors 306, causes the one or more processors 306 and/or the device 302 to perform one or more operations or processes described herein. In some implementations, hardwired circuitry is used instead of or in combination with the instructions to perform one or more operations or processes described herein. Additionally, or alternatively, processor 306 may be configured to perform one or more operations or processes described herein. Thus, implementations described herein are not limited to any specific combination of hardware circuitry and software.

The number and arrangement of components shown in FIG. 3 are provided as an example. The device 302 may include additional components, fewer components, different components, or differently arranged components than those shown in FIG. 3. Additionally, or alternatively, a set of components (e.g., one or more components) of device 302 may perform one or more functions described as being performed by another set of components of device 302.

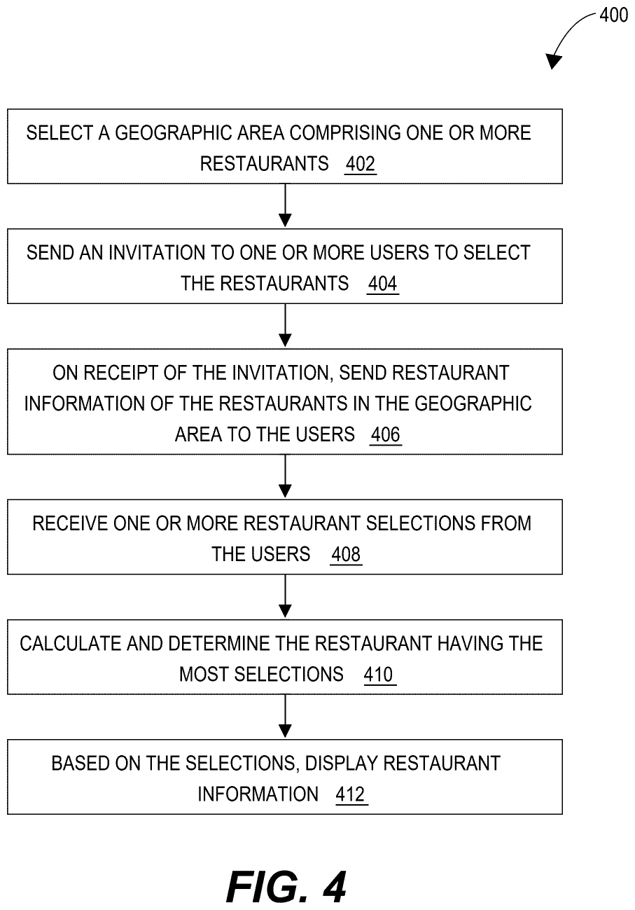

FIG. 4 shows an example work flow 400 for implementing the above-described methods and systems. The work flow 400 may, for example, be implemented on the system of FIG. 2 and/or devices of FIG. 3 In step 402 of routine 400, a user may select a geographic area comprising one or more restaurants and/or meeting locations. For example, a first user may use the first computing device 204 to select a map and a geographic radius or area for the meeting locations. In step 404, the first user may send an invitation to one or more other users to select a restaurant or meeting location. The first user may, for example, send an invitation from the first computing device 204 to the second computing device 212 and third computing device 214 of a respective second and third user. In sending an invitation a session may be created which is stored centrally on a server, and distributed to the first computing device 204, the second computing device 212, and the third computing device 214. In some embodiments, the sessions may be stored with one or more identifiers.

In step 406, on receipt of the invitation, information pertaining to one or more restaurants, such as the name and address, in the geographic area selected by the first user may be sent to all the users. The restaurants may be sent by a server, the first computing device 204, or a combination thereof. In step 408, the users may make a selection from the restaurants sent to the users. For example, the users may each vote on one of the restaurants. This selection may then be sent to the server or first computing device 204. In step 410, the computing device 204 may calculate and determines the most-selected restaurant or meeting location. For each vote of a restaurant or meeting location one or more counters may be incremented on the server. A data structure such as a list may be instantiated and associated with each session. The data structure may keep track of all of the votes using information in the counter. In step 412, based on the selection, the computing devices 204, 212, and 214 may display the restaurant or meeting location information of the selected restaurant or meeting location. The selection may be based on user votes, defined data with respect to the restaurants, or a combination thereof. In some embodiments, the server may traverse the list or data structure to determine whether one meeting location or restaurant has the most votes and package the list(s) within the session information. In some embodiments, when a location is closed or otherwise unavailable the computing devices 204, 212, and 214 may present a second or subsequent option as having the most or higher number of votes. The first computing device 204 or the server may make the selection and then transmit the selection, along with the session information, to the computing devices 204, 212, and 214 for display. Users can then meet at the displayed restaurant or meeting location.

The foregoing description of various embodiments provides illustration and description but is not intended to be exhaustive or to limit the invention to the precise form disclosed. Modifications and variations are possible in light of the above teachings or may be acquired from practice in accordance with the present invention. For example, features disclosed with respect to one embodiment may be combined with features of other embodiments without departing from the scope of the disclosure.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

What is claimed is:

1. A method in a data processing system for selecting a restaurant for a group comprising the steps of:
selecting a geographic area comprising one or more restaurants;
sending an invitation to one or more user devices to select one of the restaurants;
upon receipt of acceptance of the invitation, sending restaurant information of the restaurants in the geographic area to the users;
receiving an indication of selection of one or more restaurants by the one or more of the users;
calculating and determining the restaurant having the most selections based on the received indication of selection of one or more restaurants by one or more of the users; and
when a restaurant is determined to have the most selections, transmitting the restaurant information of the determined restaurant to the one or more user devices for display.

2. The method of claim 1, further comprising:
when no restaurant was determined to have the most selections, presenting a list of rankings in order of votes for each of the restaurants.

3. The method of claim 1, wherein selecting a geographic area further comprises:
starting a new session; and
the session is saved on the data processing system among a list of open and complete sessions.

4. The method of claim 3, wherein the sending an invitation to one or more users to select one of the restaurants comprises sending information on the session including an identifier for each of the invitees.

5. The method of claim 3, wherein the calculating and determining the restaurant having the most selections, further comprises:
receiving indication of selections from each of the one or more of the users;
for each vote of a restaurant increasing a counter for that restaurant; and
creating a data structure of the votes from each user for all the restaurants based on the counter for each restaurant.

6. The method of claim 5, wherein the data structure is a list, and the method further comprises:
traversing the list to determine whether one restaurant has more votes than all the other restaurants;
packaging the list within the session; and
sending session information to each of the invitees including the list.

7. The method of claim 1, wherein the restaurant information further comprises a restaurant name, a restaurant address, a restaurant business' hours, or food options at the restaurant that is transmitted to the one or more user devices for display via a user interface.

8. A data processing system comprising:
a memory configured to store instructions for selecting a restaurant; and
a processor configured to execute the instructions comprising:
selecting a geographic area comprising one or more restaurants;
sending an invitation to one or more user devices to select the restaurants;
on receipt of the invitation, sending restaurant information of the restaurants in the geographic area to the users;
receiving one or more restaurant selections from the users;
calculating and determining the restaurant having the most selections; and
displaying, based on the selections, a restaurant information when the restaurant is determined to have the most selections.

9. The data processing system of claim 8, wherein the processor is further configured to execute the instructions comprising:
presenting a list of rankings in order of votes for each of the restaurants when no restaurant is determined to have the most selections.

10. The data processing system of claim 8, wherein in selecting a geographic area, the processor is further configured to execute the instructions comprising starting a new session; and
saving the session on a data processing system among a list of open and complete sessions.

11. The data processing system of claim 10, wherein in sending an invitation to one or more users to select one of the restaurants the processor is further configured to execute the instructions comprising sending information on the session including an identifier for each of the invitees.

12. The data processing system of claim 10, wherein in calculating and determining the restaurant having the most selections, the processor is further configured to execute the instructions comprising:
receiving indication of selections from each of the one or more of the users;
for each vote of a restaurant increasing a counter for that restaurant; and
creating a data structure of the votes from each user for all the restaurants based on the counter for each restaurant.

13. The data processing system of claim 12, wherein the data structure is a list, and the processor is further configured to execute instructions comprising:
traversing the list to determine whether one restaurant has more votes than all the other restaurants;
packaging the list within the session; and
sending session information to each of the invitees including the list.

14. The data processing system of claim 8, wherein the restaurant information further comprises a restaurant name, a restaurant address, a restaurant business' hours, or food options at the restaurant; and the processor is further configured to execute instructions where the restaurant information is transmitted to the one or more user devices for display via a user interface.

15. A method in a data processing system for selecting a meeting location for a group, comprising:
selecting a geographic area comprising one or more meeting locations;
sending an invitation to one or more user devices to select one of the meeting locations;
upon receipt of acceptance of the invitation, sending meeting location information of the meeting locations in the geographic area to the users;
receiving an indication of selection of one or more meeting locations by the one or more of the users;
calculating and determining the meeting location having the most selections based on the received indication of selection of one or more meeting locations by one or more of the users; and
when a meeting location is determined to have the most selections, transmitting the meeting location information of the determined meeting location to the one or more user devices for display.

16. The method of claim 15, further comprising:
when no meeting location was determined to have the most selections, presenting a list of rankings in order of votes for each of the meeting locations.

17. The method of claim 15, wherein selecting a geographic area further comprises starting a new session; and
the session is saved on the data processing system among a list of open and complete sessions.

18. The method of claim 17, wherein the sending an invitation to one or more users to select one of the meeting locations comprises:
sending information on the session including an identifier for each of the invitees.

19. The method of claim 17, wherein the calculating and determining the meeting location having the most selections, further comprises:
receiving indication of selections from each of the one or more of the users;
for each vote of a meeting location, increasing a counter for that meeting location; and
creating a data structure of the votes from each user for all the meeting locations based on the counter for each meeting location.

20. The method of claim 15, wherein the meeting location is one from a list comprising a museum, a store, a coffee shop, and a park, and the displaying the meeting location information further comprises displaying via a user interface on a user's device, meeting location information comprising: a meeting location name, a meeting location address, a meeting location business' hours, or activities available at the meeting location.
